(19) United States
(12) Patent Application Publication
(10) Pub. No.: US 2016/0299030 A1
(43) Pub. Date: Oct. 13, 2016

(54) LEAKAGE MONITORING SYSTEM FOR SPACE-ENCLOSING OBJECTS AND COUPLING REGIONS LOCATED THERE BETWEEN

(71) Applicant: AREVA GMBH, Erlangen (DE)

(72) Inventors: ROBERT HORBACH, ALZENAU (DE); PAUL KLUCZEWSKI, ERLANGEN (DE); THOMAS SCHLEGL, ERLANGEN (DE); STEFAN STARK, EFFELTRICH (DE)

(21) Appl. No.: 15/185,604

(22) Filed: Jun. 17, 2016

Related U.S. Application Data
(63) Continuation of application No. PCT/EP2014/077291, filed on Dec. 10, 2014.

(30) Foreign Application Priority Data
Dec. 20, 2013 (DE) 102013227043.7

(51) Int. Cl. G01M 3/18

(52) U.S. Cl. CPC G01M 3/183

(57) ABSTRACT

A leakage monitoring system is provided for space-enclosing objects, such as pipes, hoses or containers having an exterior wall. The leakage monitoring system includes at least one electrically conductive element that acts as a leakage sensor and is mounted on the exterior wall or integrated therein. In order to make simple and reliable monitoring of imminent or already occurring leakages possible, even for extensive wall regions, and specifically in as universal a manner as possible for different types of media, the electrically conductive element is a component of a measuring bridge which contains a device for evaluating the bridge voltage and which is powered by a voltage source has an operating voltage containing both AC voltage components and DC voltage components.

### CROSS-REFERENCE TO RELATED APPLICATION

This is a continuation application, under 35 U.S.C. §120, of copending international application No. PCT/EP2014/077291, filed Dec. 10, 2014, which designated the United States; this application also claims the priority, under 35 U.S.C. §119, of German patent application No. DE 10 2013 227 043.7, filed Dec. 20, 2013; the prior applications are herewith incorporated by reference in their entirety.

### BACKGROUND OF THE INVENTION

### Field of the Invention

The invention relates to a leakage monitoring system for space-enclosing objects, in particular made of plastics material, such as pipes, hoses or containers, containing an exterior wall which separates a medium guided therein from the external environment. The system has at least one electrically conductive element acting as a leakage sensor, which is mounted on the exterior wall or integrated therein. In a specific embodiment, coupling regions or transition regions between such media-guiding enclosures, in particular pipes or hoses, which can be combined in any desired manner and sequence, are monitored in a targeted manner. The invention further relates to a corresponding method for preventative and/or direct leakage monitoring.

In many pipelines, hoses or containers of industrial facilities, in particular in nuclear power facilities, liquids or gases (generally referred to as fluids) are guided which are harmful or hazardous to the environment. This makes it necessary to monitor such fluid-guiding or media-enclosing objects for leakages.

For this purpose, different types of sensors and monitoring methods have been developed. For example, it is known to monitor the integrity of a pipe wall using electrical conductors embedded therein. In this context, published European patent application EP 2 287 587 A2 discloses a system in which a monitoring problem is solved based on the action of an electrical short circuit between two conductors incorporated in a pipe.

However, a system of this type is neither specifically configured nor sensitive enough to reliably determine even the smallest leakages of fluids, for instance at joints of a pipe wall or container wall, or through micro pores.

### SUMMARY OF THE INVENTION

The problem addressed by the present invention is that of providing a leakage monitoring system of the type mentioned at the outset which makes simple and reliable monitoring of the smallest leakages possible, even for extensive wall regions, and specifically in as universal a manner as possible for different types of fluids or media. In particular, the aim is for preventative monitoring which responds even before an actual incipient leakage, i.e. when a leakage is imminent. A corresponding method will also be provided.

Accordingly, the electrically conductive element which is mounted on the exterior wall or integrated therein is a component of a measuring bridge, which has a device for evaluating the bridge voltage and which is powered by a voltage source having an operating voltage, which contains both AC voltage components and DC voltage components. In this case, the electrically conductive or generally electrically active element can have any spatial shape and structure appropriate for the monitoring task, in particular can form a sensor layer, and is also described in short as a conductor in the following for reasons of simplification.

The invention is based on at least one electrically active sensor (e.g. a conductive network system or grid or an arrangement of wires, but also elements made of conductive or semi-conductive material in another form) being incorporated in the wall material or shell material between the external face facing away from the medium and the medium-guiding internal face. The arrangement of the sensor material is assumed as given. Any material which provides a sufficiently large change in one of their electrical parameters—in particular electrical resistance, capacitance and/or inductance—in the event of a leakage can be used as the sensor material.

In addition, it is not an actual leakage that is detected, but preferably preventative or prognostic monitoring is possible in the sense that even a change to the material or structure of the wall material prior to a leakage, for instance owing to damage, wear, erosion and the like, leads to a change in electrical parameters, which change is measured and optionally used to trigger an alarm, even before a leakage actually takes place. Within the context of this description, where leakage monitoring is referred to for reasons of simplification, it always relates to preventative monitoring of this kind of an impending or directly imminent leakage. Terms such as “leakage sensor” and the like are to be understood similarly.

The invention is based on the concept that the sensor implemented in this manner is intended to be included in the measurements in an AC voltage measuring bridge. The complex electrical resistance (impedance) is thus assessed by measuring and evaluating the bridge voltage, in particular with regard to frequency, magnitude and phase position. This takes into consideration both ohmic and capacitive and/or inductive changes in the arrangement caused by a material change resulting from the leakage or preceding it.

The actual sensor is thus an element of the measuring bridge that is integrated in the object to be monitored, for instance in a pipe wall/hose wall/container wall. The other electrical/electronic components which complete the arrangement to form a complete measuring bridge are implemented in a separate measurement circuit. The measurement arrangement can be attached to the test object in its immediate proximity or remotely.

It is essential that the measuring bridge is powered both by DC voltage and by AC voltage of a specific, known frequency. The design of the circuit makes it possible for the smallest changes in electrical parameters (caused by the material change or shape change leading to a leakage) to lead to both a large change in amplitude and a change in signal shape resulting from the superimposition of DC voltage components and AC voltage components. This increases the evaluation and assessment reliability of the generated signal with respect to interference and to the signal in the operating state.

The evaluation unit preferably contains an electronic processing unit for the measurement signal. In a simple case, the unit can be merely an indicator device for the measurement signal but can naturally also have even more and/or alternative components. For example, an electronic memory unit for the measurement signal can be provided, for instance in the form of a ring memory and/or non-volatile memory. Furthermore, a diagnostic module is advantageous, which, for example by threshold values and/or relevant evaluation algorithms, automatically detects sudden and/or long-term changes in the measurement signal, which indicate an impending/imminent/currently incipient or already occurring leakage, and/or classifies the changes into different groups of features and in particular uses the changes to trigger an alarm.

The frequency of the AC voltage is preferably switchable or covers a specific frequency range. The switching of the frequency is used in particular when, during a plausibility check of the bridge detuning, specific criteria do not lead to any conclusive assessment of the signal.

The measuring circuit is preferably band-limited, i.e. it functions only in a low frequency range around the base frequency. This design is also retained if the frequency is switched as described above.

In accordance with the measuring principle, the wall material or shell material of the object to be monitored, for instance of the pipe/hose/container, is preferably non-electrically conductive, in particular non-metallic. Instead, the method is suitable in particular for preventative and direct leakage monitoring of medium-adjoining plastics components (plastics plates, pipes, hoses, containers). However, it is also possible to monitor, in the manner described, objects which have a metal exterior wall or objects which have an existent metal-non-metal composite structure, the metal components or parts thereof forming the elements acting as sensors, which are coupled into the measuring bridge.

In monitoring a plurality of objects using a plurality of sensors and associated measuring bridges, each monitored object (this can be e.g. a pipe section or a sub-surface of a larger wall surface) can advantageously be assigned a distinct individual identifier by which it can be identified. The measurement results and assessment thereof can thus be assigned to this identifier. It is thereby possible to pinpoint the location of the change in or damage to the wall material, put simply the leakage location, which causes leakage at a later stage.

In general terms, the described monitoring device can be included in a system which is able to provide location information with regard to the damage. This is possible in particular if the sensor element or the electrode of the measurement circuit is assigned one-to-one to a signal-processing unit, which in turn links the measured signal to a system-wide one-to-one identification.

It is also possible to divide an arrangement of the monitoring locations into individual sections, which are connected to a central processing apparatus. The original and the assessed measurement signal can be transmitted via a bus system to the central processing apparatus (e.g. host computer).

By the measuring arrangement according to the invention, vibrations or shock in space-enclosing objects such as pipes, hoses or containers and/or coupling regions located there between can also be monitored. This monitoring can take place in the described manner by impedance measurement in the region of the exterior wall of the monitored object and by evaluation of the temporal changes. In other words, in evaluating temporal impedance changes, conclusions are drawn on movements or accelerations of pipe segments or other segments causing such changes. Alternatively or additionally, determined acceleration sensors, in particular in chip form, can be arranged in/on the object, which sensors directly provide corresponding acceleration measurement values.

Vibration or shock monitoring of this kind can have in particular one or more of the following objectives, exemplified here using the example of a pipeline:

a) Intrusion detection: monitoring a pipeline for mechanical manipulations, e.g. targeted tapping or by vandalism, but also detecting building work in the vicinity which would threaten the safety or integrity of the pipeline.
b) Seismic monitoring: seismic activities can be detected in the entire pipeline. The epicenter can be located by locating the measuring point. The measurement data are stored and evaluated for the aging management.
c) Operating vibrations: vibrations which result during operation are detected and recorded. Short-term events such as cavitation are detected. The detected measurement data are likewise centrally stored and evaluated for the aging management.

In order to be able to check the condition of the measuring arrangement, reference circuits are provided which can generate a known signal and which input this signal into the measuring bridge instead of the sensor signal when in the test or checking mode, and optionally for the purposes of calibration.

The arrangement can also be provided with moisture sensors and/or temperature sensors and/or other sensors (for instance acceleration sensors) for detecting the environmental conditions or specific material properties. Further statistical or measurement assessments can thus then be carried out.

In this context, the temperature measurement is of particular interest. Similarly to the vibration monitoring, preferably at least one temperature sensor is implemented/installed on each monitoring module or pipe segment in question. The temperature sensor can be integrated on/at the inner face or the outer face of the fluid-guiding enclosure or also in the wall.

Temperature measurement values are preferably read cyclically and stored centrally in a database. There are two advantageous basic types of evaluation:

A posteriori: For the pre-leakage alarm, the stored temperature data are investigated and it is identified whether material fatigue caused by temperature has occurred.

A priori: By considering the temperature data, a reliable prognosis can be made for discrete pipe segments with respect to the maximum service life/operational life expectation. A recommendation for replacement to the operator is derived therefrom.

Generally, preferably all the measurement data from pre-leakage monitoring, vibration monitoring and temperature monitoring are stored in a database. All the data can be interlinked. By suitable weighting of the individual influencing factors, a trend can be calculated for each monitoring module or pipe segment in question (aging management).

The measurement arrangement can be networked and exchange information with other locations via a data network, for example in order to stabilize the sensor signals with respect to climatic influences. It is also possible to externally check the measurement arrangement, adjust the parameters thereof or retrieve information therefrom.

The arrangement and method preferably lead to the generation of warnings or alarms or of information which can be used to trigger an alarm. It is possible to monitor the object in question continuously or cyclically.

So far, the focus of the description has been on the monitoring of planar regions, in particular the leakage monitoring of pipe bodies. Similarly, coupling regions and transition regions in pipe/hose/container connections and similar object connections can also be monitored in a targeted manner for a change in or damage to the coupling gap between the two interconnected components leading to or encouraging leakage. In this case too, a mainly electrically non-conductive characteristic of the pipe wall material, at least in the coupling region, is preferred.

In this case, the preferred arrangement of the electrical conductor forming the leakage sensor substantially contains one or more conductive rings which completely enclose the connection location and form the electrodes of an electrical measurement circuit. The rings can be in particular electrically conductive O-rings or other annular or hollow-cylinder-shaped objects in specific applications which can also undertake sealing functions. The measurement circuit is designed such that the leakage-encouraging changes in this region lead to an essential detuning of the electrical operating point. A change of this kind can thus be clearly detected, in particular after a medium-based assessment of the change, e.g. of the conductivity. In other words, a significant change in electrical parameters, generally the (complex) impedance, of the enclosing arrangement of electrically conductive rings can also be ascertained here, which change can be measured in particular using the above-described bridge circuit.

For the general application “pipe leakage monitoring”, it is obviously possible to couple or to combine the monitoring of the pipe body (surface monitoring) and the coupling between pipe segments. Generally, this also applies to non-tubular objects.

The advantages achieved by the invention are particular in that, as a result of the careful combination of a measurement method and suitable signal-processing methods, it is possible to reliably detect and pinpoint even minor leakages “in statu nascendi” or even sooner (in the sense of preventative monitoring) in media-guiding pipelines, hoses, flow paths, tanks, containers and the like. Targeted monitoring of pipe couplings and similar connection points of medium-guiding enclosures is also possible. Essential aspects with regard to the sensitivity achieved lie in the selection of the measuring bridge power supply, in the evaluation of the resulting measuring bridge signal and in the manner in which a small change in the sensor signal can generate a large signal deviation. The integrated and permanently available method is thus robust and leads to a sufficient signal distance between the normal state and the leakage-encouraging fault state. In addition, the sensor arrangement can be easily manufactured using materials that are available on the market and are capable of a long service life.

Other features which are considered as characteristic for the invention are set forth in the appended claims.

Although the invention is illustrated and described herein as embodied in a leakage monitoring system for space-enclosing objects and coupling regions located there between and related method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a highly simplified and schematic basic circuit diagram of a leakage monitoring system for space-enclosing objects such as pipes, hoses or containers according to the invention;

FIG. 2 is a graph showing an example of a course over time of a measuring signal recorded using a leakage monitoring system according to FIG. 1;

FIG. 3 is a diagrammatic, longitudinal sectional view through a pipe coupling having an arrangement of electrodes for leakage detection in this region (only half of a pipe is shown);

FIG. 4 is an enlarged diagrammatic, longitudinal sectional view of a portion of FIG. 3; and

FIG. 5 is an illustration of a detail from FIG. 4.

### DETAILED DESCRIPTION OF THE INVENTION

In all the figures, like parts are provided with the same reference signs.

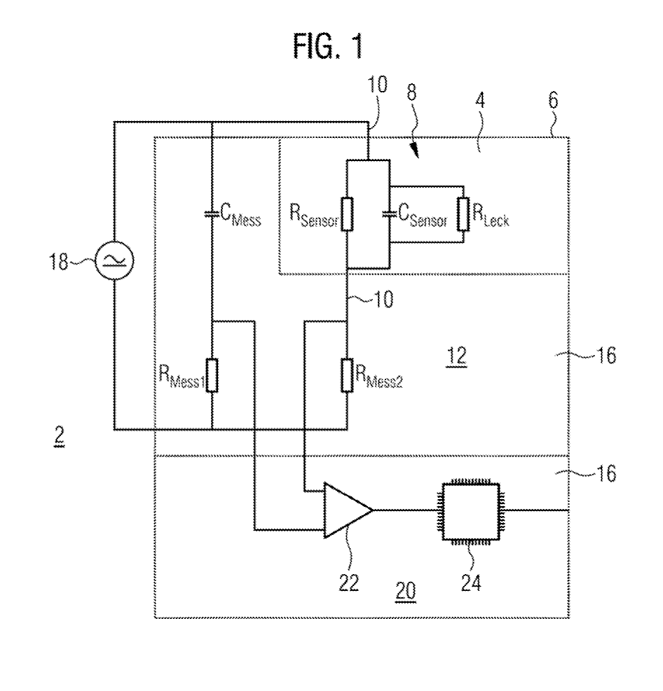

Referring now to the figures of the drawings in detail and first, particularly to FIG. 1 thereof, there is shown a leakage monitoring system 2 in a very abstract form and serves to detect even the smallest changes which, over time, could lead to fluid or medium guided in a pipe 4 leaking through the pipe wall or exterior wall 6 to the outside. The exterior wall 6 thus forms the (as impermeable as possible) geometric limit of a flow channel or receiving volume for the enclosed medium or fluid.

A further example is the monitoring of planar plastics components, as used in container construction.

For this purpose, a sensor 8 in the form of an electrically conductive material, here for example in the form of a wire mesh or woven fabric, is integrated in the electrically non-conductive shell material of the exterior wall 6, which consists of a plastics material. Specifically, the embodiment uses a GRP pipe, in the wall of which at least one metal fiber or carbon fiber or CFRP woven fabric has been incorporated as an electrically conductive sensor. GRP stands for glass fiber reinforced plastics material and CFRP stands for carbon fiber reinforced plastics material. The extent of the conductive woven fabric preferably covers the whole of the wall surface to be monitored.

The electrically conductive woven fabric is connected at two points, which are as far away from one another as possible, for instance at either end of the pipe, to one electrical supply line 10 in each case, which is guided out of the exterior wall 6 of the pipe 4. The bipolar sensor 8 implemented thereby can be generally characterized in the equivalent circuit diagram shown as a parallel circuit of an ohmic resistor RSensor and a capacitor CSensor. The equivalent circuit diagram is only to be understood by way of example; more complicated cases may occur in practice which have alternatively or additionally available inductors in a parallel circuit and/or series circuit.

In the case of an impending leakage of fluid or medium guided in the pipe 4 through the exterior wall 6 to the outside, caused for example by mechanical wear or damage, at least one of the electrical parameters of resistance, capacitance and/or inductance of the sensor 8 changes. Reasons for this could be, for example, a local change in the dielectricity and/or mechanical deformation of the conductive woven fabric at breaking points. This is shown in the equivalent circuit diagram (again only by way of example) by the ohmic additional resistor RLeck, here in a parallel circuit with the resistor RSensor. In general, the capacitance and the inductance of the sensor 8 can change as a result of the change in the pipe wall and/or the leakage flow. Very generally, it can be said that the complex AC resistance (impedance) of the sensor 8 changes when there is a leakage-encouraging structural change.

In order to detect impedance changes of this kind, which can turn out comparatively small for minor changes, the sensor 8 integrated in the pipe 4 is coupled via its supply lines 10 into an AC voltage measuring bridge (measuring bridge 12 for short), which is constructed according to the basic principle of a Wheatstone measuring bridge and is implemented specifically for example as a Wien bridge or Maxwell-Wien bridge. The electronic components required for the completion of the bridge circuit and for the evaluation, which are shown here purely schematically and by way of example by a measuring resistor RMess1, a measuring resistor RMess2 and a measuring capacitor CMess, are transferred into a measurement circuit 16 arranged outside the pipe 4. In general, the measurement circuit 16 can contain three complex measuring resistors instead of the idealized electrical components RMess1, RMess2 and CMess, which resistors form, together with the complex sensor resistor of the sensor 8, the measuring bridge 12, on the bridge branch of which a voltage signal VMess (diagonal voltage or bridge transverse voltage) is sensed.

In the embodiment, the voltage signal VMess sensed in the analogue part of the measurement circuit 16 is supplied to a digital evaluation device 20 via corresponding connections and wires, which device contains, for example, an operational amplifier 22 or other signal amplifier and a microcontroller 24. A non-illustrated display device is expediently provided for the purpose of visualizing the measurement results which are processed in the evaluation device 20 and optionally assessed with respect to a possible leakage.

In contrast to the DC voltage-powered Wheatstone bridge, the measuring bridge 12 is powered by a voltage source 18 having an operating voltage UG, which contains both AC voltage components, preferably having a single fixed base frequency ω, and DC voltage components, specifically in the form of a superimposition or superposition, thus for example U(t)=U0+U1 cos(ωt). The bridge transverse voltage VMess sensed in the bridge branch therefore usually changes drastically, even if the impedance of the sensor 8 only changes slightly as a result of a leakage or a structural change leading to a leakage.

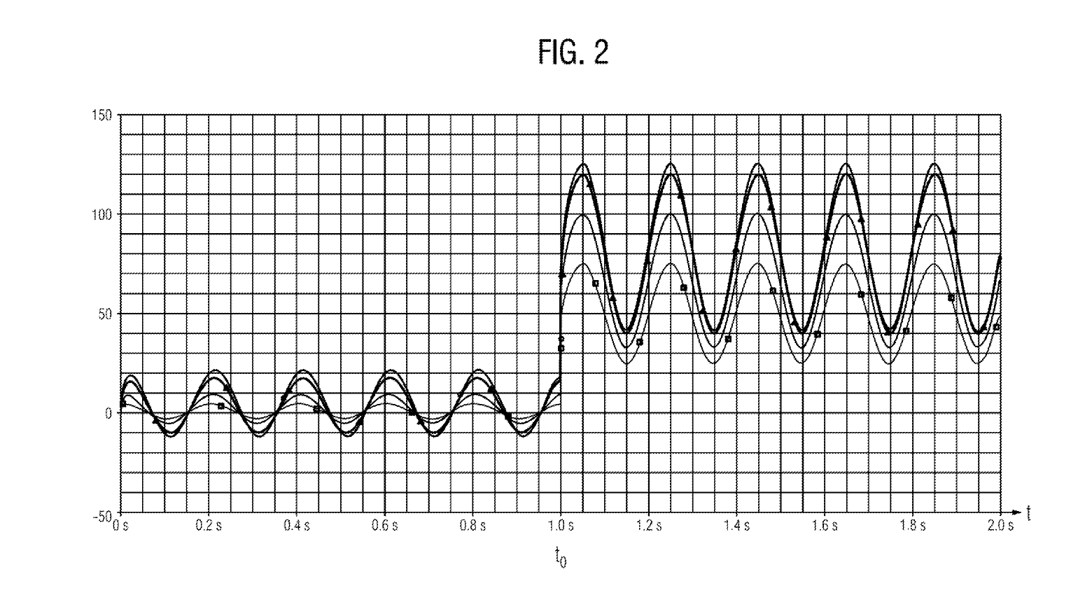

This is illustrated in FIG. 2, which shows the voltage signal VMess applied in the bridge branch as a function of time t. We see that a change to the monitored pipe section that encourages or is associated with a leakage and is applied at a time tO has a drastic impact on the signal shape, in particular increases the signal-to-noise ratio, and this can be used to trigger an alarm manually or in an automated manner. In addition, further functional modules (not shown here) can be integrated in the measurement circuit 16 according to FIG. 1 or can be coupled thereto.

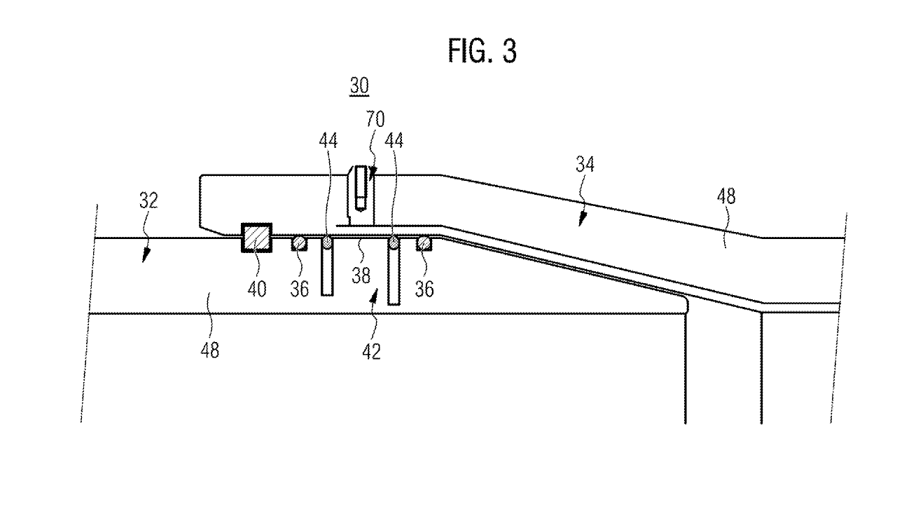

FIG. 3 illustrates a specific case of the monitoring apparatus in a GRP pipeline, specifically in the region of the coupling 30 between two pipe segments 32, 34. A first pipe segment 32, here the left-hand segment, contains at its end a portion having a tapering external diameter and is inserted with a perfect fit into a second pipe segment 34, here the right-hand segment, which contains at its end a portion having a correspondingly widening internal diameter. Two peripheral O-ring seals 36 seal the annular/hollow cylindrical gap 38 between the two pipe segments 32, 34. In addition, a peripheral clip 40 functions as a mechanical catch and lock for the coupling 30. For example, a bayonet lock or the like can be provided.

For (preventative) detection of imminent or occurring leakage of flow medium from the inside of the pipe through the gap 38 into the surroundings, as can particularly occur when there is damage to the two O-ring seals 36, a leakage sensor 42 is integrated in the coupling region. Here, the leakage sensor 42 substantially contains two (generally at least one) electrically conductive rings 44 which are attached to the inner pipe segment 32 and protrude into the gap 38 and which form the electrodes of an associated measurement circuit, which can consist of a bridge circuit powered simultaneously by AC voltage and DC voltage, similarly to the embodiment according to FIG. 1. The explanations there with regard to the measuring principle and to the evaluation and alarm triggering also apply similarly here.

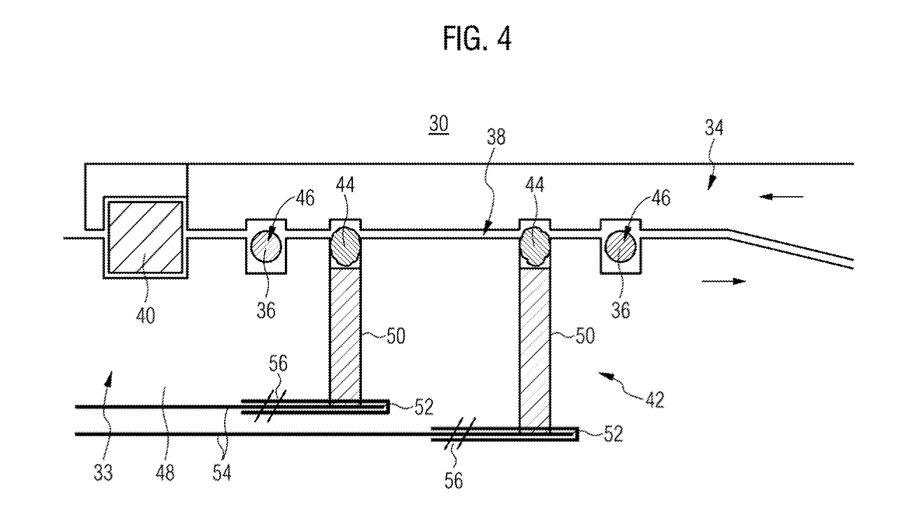

FIG. 4 enlarges some of the details from FIG. 3, specifically the detailed shape and the electrical contacting of the electrodes 46. We see that the metal-braid rings 44 which protrude into the gap 38 between the two pipe segments 32, 34 and form the electrodes 46 are contacted by metal sleeves 50 which are arranged radially in corresponding recesses in the pipe wall 48 of the inner pipe segment 32. At the opposite end, the metal sleeves 50 are each connected by an electrically/mechanically stable connection, here by spot welding using a contact clip 52 embedded in the pipe wall 48, to which clip an electrical supply line 54 is clamped using a connecting element 56.

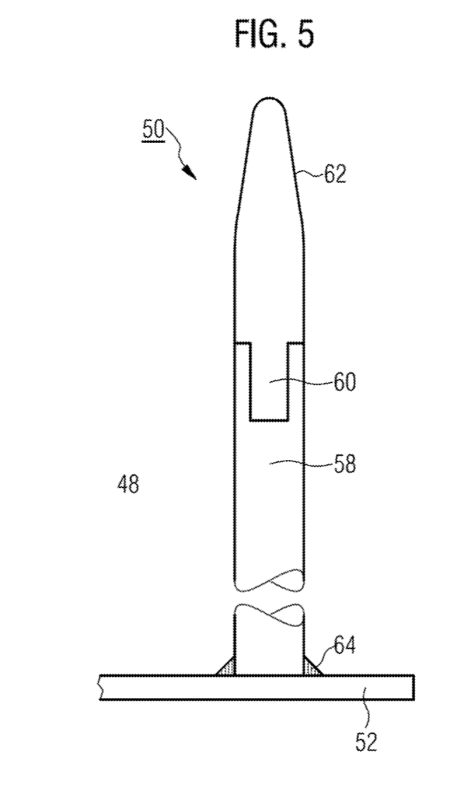

One of the metal sleeves 50 is shown enlarged in cross section in FIG. 5. The sleeve contains a cylindrical anchor part 58 which is securely inserted into the pipe wall 48, and an attachment part 62 in the form of a spike which can be screwed into the anchor part 58 by a threaded extension 60. In the final assembled state, the tip of the spike protrudes from the pipe wall 48 and into the gap 38. At the end protruding into the pipe wall 48, the anchor part 58 is welded at its end face to the contact clip 52, which is shown by the brazing solder weld seam 64.

The attachment part 62 can be removed after production for the purpose of electrical contacting. An electrical connection is then possible at the threaded extension 60, which connection is part of the measurement circuit shown in FIG. 1.

The following is a summary list of reference numerals and the corresponding structure used in the above description of the invention:
2 Leakage monitoring system
4 Pipe
6 Exterior wall
8 Sensor
10 Supply line
12 Measuring bridge
16 Measurement circuit
18 Voltage source
20 Evaluation device
22 Operational amplifier
24 Microcontroller
30 Coupling
32 Pipe segment
34 Pipe segment
36 O-ring seal
38 Gap
40 Clip
42 Leakage sensor
44 Ring
46 Electrode
48 Pipe wall
50 Metal sleeve
52 Contact clip
54 Supply line
56 Connecting element
58 Anchor part
60 Threaded extension
62 Top part
64 Weld seam
70 Contact sleeve
C Capacitor
R Resistor
U, V Voltage
t Time

1. A leakage monitoring system for a space-enclosing object having an exterior wall, the leakage monitoring system comprising:
a measuring bridge having at least one electrically conductive element acting as a leakage sensor mounted on the exterior wall or integrated therein;
a voltage source outputting an operating voltage containing both AC voltage components and DC voltage components for powering said measuring bridge; and
a device for evaluating a bridge voltage, said evaluation device configured to measure both a change in amplitude and a change in signal shape.

2. The leakage monitoring system according to claim 1, further comprising means for switching between at least two different base frequencies.

3. The leakage monitoring system according to claim 1, wherein said evaluation device has an electronic processing device for evaluating the bridge voltage.

4. The leakage monitoring system according to claim 1, wherein said evaluation device contains an alarm signalling device and a diagnostic device connected to said alarm signalling device.

5. The leakage monitoring system according to claim 1, wherein the exterior wall is made, at least predominantly, of a plastic material.

6. The leakage monitoring system according to claim 1, wherein said electrically conductive element contains a wire, a wire mesh, a wire grid, a ring or a cylinder enclosing the space-enclosing object.

7. The leakage monitoring system according to claim 1, wherein said leakage sensor is disposed in a region of a coupling between two objects.

8. The leakage monitoring system according to claim 1, further comprising:
a number of temperature sensors and/or acceleration sensors disposed in/on the exterior wall;
means for recording readings supplied by said leakage sensor, said temperature sensors and/or said acceleration sensors and disposed in a database; and
a diagnostic device for linking different readings.

9. The leakage monitoring system according to claim 7, wherein the objects are selected from the group consisting of pipes, hoses and container segments.

10. A leakage monitoring system for a connection or coupling region in a pipe or hose connection, wherein, in a connected state, a first pipe or hose segment is connected to a second pipe or hose segment under formation of a gap, the leakage monitoring system comprising:
two sealing elements disposed behind one another as seen in a longitudinal direction of the pipe or hose connection for sealing the gap; and
at least one electrode functioning as a leakage sensor and disposed so as to protrude into the gap between said two sealing elements.

11. The leakage monitoring system according to claim 10, wherein said electrode is one of two electrodes disposed behind one another and are disposed in the gap between said two sealing elements.

12. The leakage monitoring system according to claim 10, wherein the gap is hollow-cylindrical.

13. The leakage monitoring system according to claim 12, wherein said electrode is annular.

14. The leakage monitoring system according to claim 10, wherein each of said sealing elements is an O-ring seal.

15. The leakage monitoring system according to claim 10, wherein one of the first and second pipes or hose segments is placed onto the other pipe or hose segment to produce the pipe or hose connection.

16. The leakage monitoring system according to claim 10, further comprising a measurement device connected to said electrode, said measurement device is configured to detect an impedance change in the gap.
